(19) United States
(12) Patent Application Publication
(10) Pub. No.: US 2025/0132951 A1
(43) Pub. Date: Apr. 24, 2025

(54) METHODS, SYSTEMS AND DEVICES FOR COORDINATING A PLURALITY OF NODES IN A 10BASE-T1S ETHERNET NETWORK

(71) Applicant: Scheider Electric Industries SAS, Rueil-Malmaison (FR)

(72) Inventors: Julien MICHEL, Montchaboud (FR); Vincent Berrondo, Grenoble (FR)

(73) Assignee: Scheider Electric Industries SAS, Rueil-Malmaison (FR)

(21) Appl. No.: 18/682,172

(22) PCT Filed: Aug. 8, 2022
(86) PCT No.: PCT/EP2022/072183

§ 371 Date: Feb. 8, 2024

(30) Foreign Application Priority Data
Aug. 9, 2021 (EP) 21306106.2

(51) Int. Cl. H04L 12/413; H04L 12/40

(52) U.S. Cl. CPC H04L 12/413; H04L 12/4015

(57) ABSTRACT

A method for configuring a plurality of nodes in a 10BASE-TIS Ethernet network, in which nodes are configured to implement a physical layer collision avoidance (PLCA) process. The method includes automatically selecting a selected coordinator node being at least one of a first coordinator node and a second coordinator node. Automatically selecting a selected coordinator node includes, by each node of the network: repeatedly listening for a selected coordinator broadcast to the network during one or more listening cycles, each listening cycle being at least as long as a transmission cycle, selecting a node as selected coordinator node if capable of being so selected and if the node has not detected the selected coordinator broadcast during a listening cycle, not selecting a node as selected coordinator node if the node has received the selected coordinator broadcast during at least one listening cycle.

### TECHNICAL FIELD

The present disclosure relates to Ethernet communications and relates more particularly to improvements of physical layer collision avoidance methods for Ethernet networks, such as single twisted pair Ethernet networks (10BASE-T1S).

### BACKGROUND

Electrical systems such as electrical panels usually comprise many electrical devices, such as so-called “smart” switchgear devices, measurement devices, and so on, having communication capabilities for operation as a node on a wired communications network.

For practical reasons, the nodes are often connected to the network in a bus-like arrangement, e.g. with a multidrop network topology, in which a data carrier is shared by multiple nodes.

It is thus necessary for the nodes of the network to implement a collision avoidance method, in order to avoid collisions and data loss when communicating on the network.

For example, some networks, such as 10BASE-T1S Ethernet networks, implement a physical layer collision avoidance (PLCA) method, as described in the IEEE 802.3cg-2019 standard. This method relies in part on the assumption that each node has been assigned a unique node identifier or PLCA identifier.

A drawback of this method is that there is no standard method to automatically assign a PLCA identifier to a node. Thus, users must manually allocate a unique identifier to each node connected to the network. This may be impractical in many applications, in which nodes are often added to the network or removed from the network during operation. This is for example the case in electrical distribution systems and especially electrical panels, in which electrical devices may have to be replaced during installation, or repairs, or routine maintenance operations.

Thus, every time a node is added to the network, a unique identifier must be assigned to this node. This operation can be particularly time consuming and error prone in networks comprising a large number of nodes, as is often the case in electrical distribution systems. Users tasked with this operation must keep track of which identifiers have been already allocated in order to avoid assigning the same identifier twice to two different nodes. Failure to do so may result in data loss and improper operation of the electrical system.

### SUMMARY

It is therefore desirable to provide solutions to improve physical layer collision avoidance methods in wired communication networks.

An aspect of the invention relates to a method for configuring a plurality of nodes in a 10BASE-T1S Ethernet network, said nodes being configured to implement a physical layer collision avoidance (PLCA) process, wherein the network comprises:
a first coordinator node being configured to periodically send a PLCA beacon to the network to initiate each respective transmission cycle of a PLCA process; and
a second coordinator node being configured to open a plurality of separate transmission opportunities each with a unique PLCA identifier from a pool of PLCA identifiers provided by the second coordinator, each PLCA identifier being assignable by the second coordinator to a unique physical identifier each provided by a respective node, each transmission opportunity allowing only one of said nodes to send data to the network at any one time,

wherein the method comprises automatically selecting a selected coordinator node being at least one of the first coordinator node and the second coordinator node, wherein automatically selecting a selected coordinator node comprises, by each node of the network:
repeatedly listening for a selected coordinator broadcast to the network during one or more listening cycles, each listening cycle being at least as long as a transmission cycle,
selecting a node as selected coordinator node if capable of being so selected and if said node has not detected said selected coordinator broadcast during a listening cycle,
not selecting a node as selected coordinator node if said node has received said selected coordinator broadcast during at least one listening cycle.

According to this method, the first and/or second coordinator nodes is/are automatically selected prior to automatic allocation of the transmit opportunity slots to the other device nodes. Unique PLCA identifiers can then be allocated dynamically and in a decentralized fashion to the nodes of the network. The system can update itself to allow for fewer or for more nodes. A continual looped cycle on the part of the ordinary device nodes allows for an automatic re-selection of a different first and/or second coordinator node after network start-up in case one or the other coordinator nodes disappear. In that case, thanks to the invention, a new coordinator node will be elected to replace the missing coordinator node, in order to allow the PLCA system to continue to operate.

This is a distributed solution as it does not depend on any particular privileged device on the network. Instead, the method is decentralized and implemented by the devices connected to the network.

In other embodiments, the invention may advantageously comprise one or more of the following technical features, considered alone or according to all possible technical combinations:
automatically selecting the first coordinator node as the selected coordinator node comprises, by each node of the network:
   repeatedly listening for a selected coordinator broadcast comprising a PLCA beacon during one or more first listening cycles, each first listening cycle being at least as long as a transmission cycle,
   selecting a node as the first coordinator node if capable of being the first coordinator node and if said node has not detected said PLCA beacon during one first listening cycle,
   not selecting a node as the first coordinator node if said node has received said PLCA beacon during at least one first listening cycle, and
   upon selection of the first coordinator node, assigning an initial transmit opportunity to the newly selected first coordinator node.
automatically selecting the second coordinator node as the selected coordinator node comprises, by each node of the network,
   repeatedly listening for a selected coordinator broadcast comprising a second coordinator node presence signal during one or more second listening cycles, each second listening cycle being at least as long as a transmission cycle,
   selecting a node as the second coordinator node if capable of being the second coordinator node and if said node has not detected the second coordinator node presence signal during one second listening cycle,
   not designating a node as the second coordinator node if said node has received the second coordinator node presence signal during at least one second listening cycle.
the second coordinator node is the same node as the first coordinator node and is assigned the PLCA identifier of the initial transmit opportunity.
the second coordinator node is different from the first coordinator node and is assigned a PLCA identifier different to the PLCA identifier of the initial transmit opportunity.
the method comprises automatically assigning a unique PLCA identifier to each node by means of:
   each node broadcasting its presence, optionally broadcasting its presence periodically, to the network so that the second coordinator node may assign any unassigned PLCA identifiers to any unassigned nodes; and/or
   each unassigned node deducing its PLCA identifier from a PLCA identifier message broadcast, optionally broadcast periodically, by the second coordinator node.
the second coordinator node periodically updates any PLCA identifier message with any changes in the pool of PLCA identifiers.
each assigned node signals its presence and/or transmits data during its transmit opportunity, until said node is disconnected from or unavailable to the network.
the second coordinator node is arranged to free a PLCA identifier of a node disconnected from, or unavailable to, the network and update the pool of PLCA identifiers accordingly.
the second coordinator node is arranged to assign a free PLCA identifier to a new node connected or available to the network and update the pool of PLCA identifiers accordingly.
the second coordinator node comprises a memory for storing the pool of PLCA identifiers.
each node comprises a memory for storing a unique PLCA identifier assigned to said node.
each node stores its unique physical identifier in its memory.
the unique physical identifier of each node is programmable.

According to another aspect, a system comprises a plurality of nodes connected to a 10BASE-T1S Ethernet network, said nodes being configured to implement a physical layer collision avoidance process, each node comprising a processor, a memory and a network interface configured to implement a network stack,
wherein the network comprises:
   a first coordinator node being configured to periodically send a PLCA beacon to the network to initiate each respective transmission cycle of a PLCA process; and
   a second coordinator node being configured to open a plurality of separate transmission opportunities each with a unique PLCA identifier from a pool of PLCA identifiers provided by the second coordinator, each PLCA identifier being assignable by the second coordinator to a unique physical identifier each provided by a respective node, each transmission opportunity allowing only one of said nodes to send data to the network at any one time,
wherein the memory is storing instructions configured to cause the processor to implement a method for configuring a plurality of nodes,
wherein the method comprises automatically selecting a selected coordinator node being at least one of the first coordinator node and the second coordinator node,
wherein automatically selecting a selected coordinator node comprises, by each node of the network:
   repeatedly listening for a selected coordinator broadcast to the network during one or more listening cycles, each listening cycle being at least as long as a transmission cycle,
   selecting a node as selected coordinator node if capable of being so selected and if said node has not detected said selected coordinator broadcast during a listening cycle,
   not selecting a node as selected coordinator node if said node has received said selected coordinator broadcast during at least one listening cycle.

### BRIEF DESCRIPTION OF THE DRAWINGS

The invention will be further understood upon reading the following description, provided solely as a non-limiting example, and made in reference to the appended drawings, in which:

FIG. 1 is a schematic diagram of a network comprising a plurality of nodes according to embodiments of the invention;

FIG. 2 is a block diagram of a node of the network of FIG. 1 according to an embodiment;

FIG. 3 is a chronogram illustrating a transmission cycle in the network of FIG. 1;

FIG. 4 is a flow chart depicting an exemplary method for automatically selecting a first coordinator node among the nodes of the network of FIG. 1;

FIG. 5 is a flow chart depicting an exemplary method for automatically selecting a second coordinator node among the nodes of the network of FIG. 1;

FIG. 6 is a flow chart depicting an exemplary method for automatic allocation of PLCA identifier to nodes of the network of FIG. 1;

FIG. 7 is a flow chart depicting an exemplary method for automatic allocation of a PLCA identifier by nodes of the network of FIG. 1.

### DETAILED DESCRIPTION OF SOME EMBODIMENTS

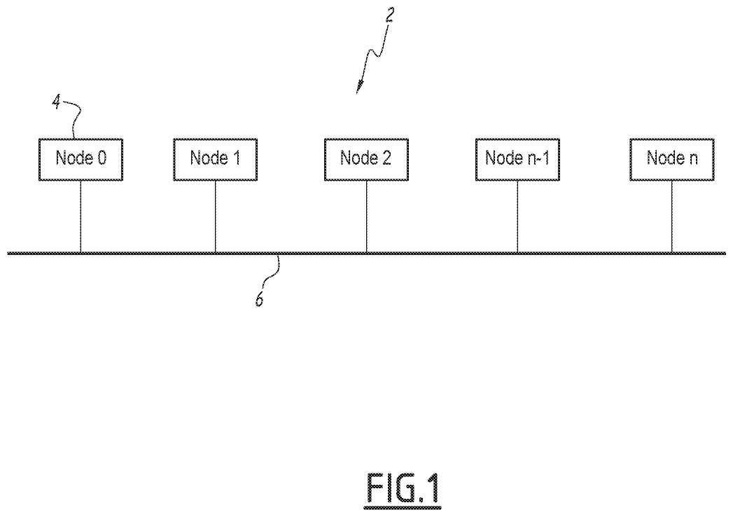

FIG. 1 illustrates an exemplary network according to embodiments of the invention. A system 2 comprises a plurality of nodes 4 connected to a wired communications network 6, preferably a multidrop network.

Preferably, the Ethernet network is a single twisted pair Ethernet network, also known as a 10BASE-T1S network, as described in the IEEE 802.3cg-2019 standard, which is incorporated herein by reference.

In the illustrated example, the nodes 4 are connected to a network media such as a single Ethernet cable 6, preferably with a multidrop topology. Other embodiments are possible, such as a daisy chain topology (using only one network interface per node) or a point-to-point topology.

In this example, the system 2 comprises n+1 nodes, where “n” is a nonzero integer.

The nodes 4 are numbered from “Node 0” through “Node n”, and only some of the nodes 4 are illustrated on FIG. 1 for simplicity.

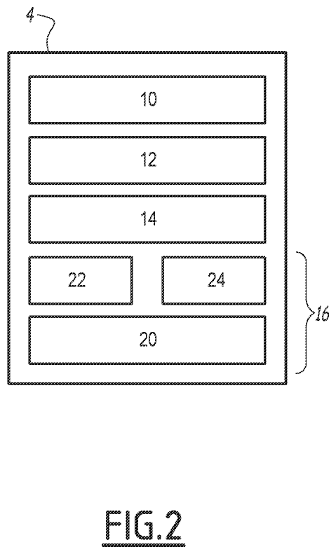

For example, the Ethernet cable 6 is a single twisted pair Ethernet cable. FIG. 2 schematically illustrates an exemplary node 4.

Preferably, the nodes 4 are electrical devices, such as switchgear devices, or electrical measurement devices. The nodes 4 are preferably part of an electrical system such as an electrical distribution system, or an industrial control system, or the like.

For example, one or mode nodes 4 may be removable electrical switchgear devices mounted in an electrical panel or in an electrical cabinet.

Other embodiments are nonetheless possible.

In some embodiments, each node 4 is configured to implement a main function 10 in the system 2, such as interrupting an electrical current, or measuring electrical parameters, or detecting an electrical fault, or the like, depending on the nature of the corresponding device.

Each node 4 comprises a processor 12, a memory 14 and a network interface 16 configured to implement a network stack 20. For example, the network interface 16 comprises an Ethernet connector for connecting to the Ethernet network 6.

Each node 4 also comprises a unique physical identifier (UID) identifying the corresponding node of the network (such as a hardware identifier of that node, e.g. a MAC address of that node), as will be explained below.

According to advantageous aspects, the node 4 (or the network interface 16) may be configured to store a first identifier 22 denoting its role as a coordinator node or an ordinary node. The node 4 is configured to store a unique network identifier 24 for identifying the node 4 on the network 6. Other embodiments are nonetheless possible.

In what follows, the first identifier 22 will also be named first parameter, in order to prevent confusion with the physical identifier or with the network identifier.

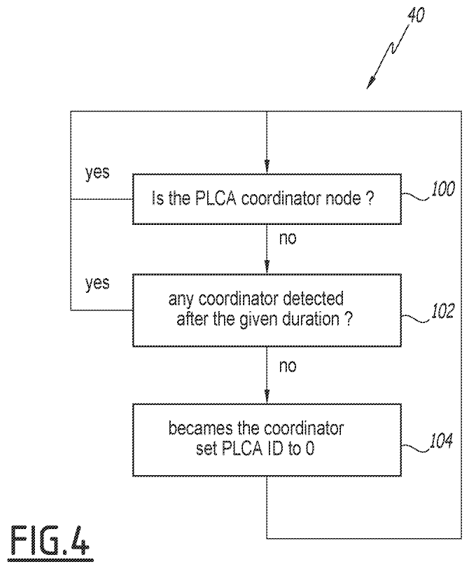

The memory 14 stores instructions and/or computer code configured to, when executed by the processor 12, cause the processor 12 to execute methods for coordinating a plurality of nodes 4, as will be described herein in reference to FIGS. 4 through 7.

In this specification, the expression “processor” refers not only to electronic controller devices including a processor or a microprocessor, but also to other equivalent elements such as programmable logic controllers (PLC), application-specific integrated circuits (ASIC), field-programmable gate array (FGPA) circuits, logic circuits, analog electronic circuitry, equivalents thereof, any combination thereof, and any other circuit or processor capable of executing the functions described herein.

The nodes 4 are configured to implement a physical layer collision avoidance (PLCA) process, e.g. as described in clause § 148 et seq. of the IEEE 802.3cg-2019 standard.

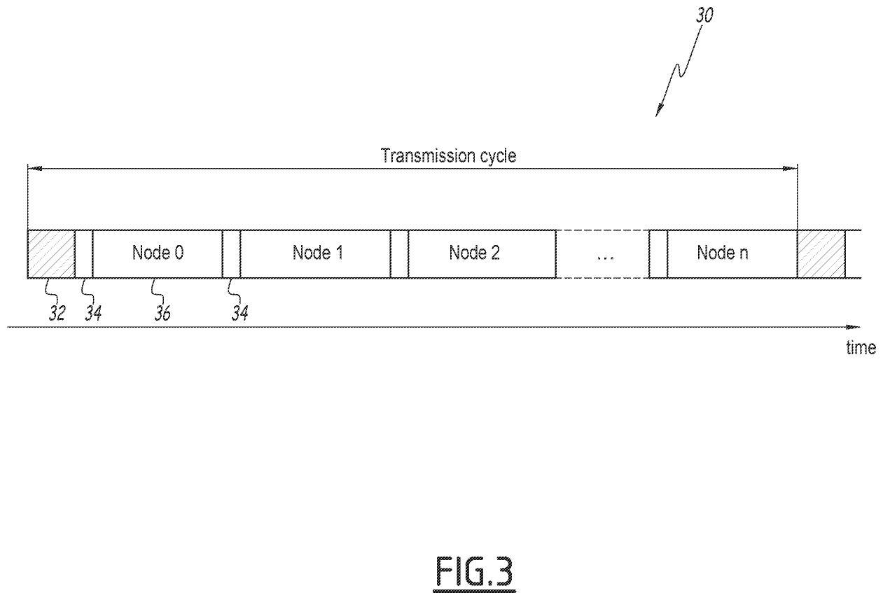

An exemplary mode of operation of the physical layer collision avoidance (PLCA) process is described in reference to the chronogram of FIG. 3.

The chronogram 30 of FIG. 3 schematically illustrates data exchanged over the network 6 (i.e. over the Ethernet cable 6 shared by the nodes 4) over time, and more specifically during a transmission cycle. Transmission cycles may be repeated periodically with a fixed frequency and a fixed duration.

For example, a first node 4 is initially chosen among the plurality of nodes 4 to act as a first coordinator node, or PLCA coordinator node.

The first coordinator node is configured to periodically send a PLCA beacon to the network to initialize each respective transmission cycle of a PLCA process.

The first coordinator node, which is noted “Node 0” in this example, is configured to periodically send (broadcast) a beacon 32, also named PLCA beacon, to the Ethernet network in order to initiate a new transmission cycle.

A second coordinator node is also initially chosen among the plurality of nodes 4 to act as a second coordinator node, also named identifier-manager coordinator node.

The second coordinator node is configured to, for example during each transmission cycle, open a plurality of separate transmission opportunities (TO), each transmission opportunity allowing only one of said nodes 4 to send data to the network 6.

More precisely, the second coordinator node is configured to allocate a PLCA identifier to any ordinary node that has no allocated PLCA identifier.

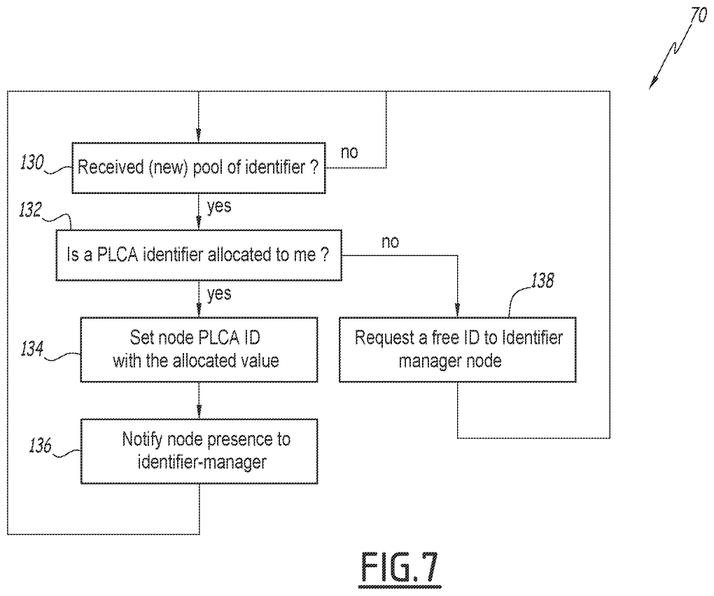

For example, at the beginning, until any node has been allocated a PLCA identifier, and whenever a new node is being allocated a PLCA identifier, the second coordinator node is using its transmit opportunity to send a message containing the list of allocated PLCA identifiers and the corresponding nodes, so that any node may know what PLCA identifier has been allocated to it. Once a node has been allocated a PLCA identifier (and has taken this allocation into account as will be described in reference to FIG. 7 below) then that node may use its transmit opportunity window at every PLCA cycle. Possibly this can be done even if the second coordinator has not finished allocating a PLCA ID to each node.

In practice, the second coordinator is configured to open a plurality of separate transmission opportunities (TO) each with a unique PLCA identifier (PLCA ID) from a pool (P) of PLCA identifiers provided by the second coordinator, each PLCA identifier being assignable by the second coordinator to a unique physical identifier (UID) each provided by a respective node, each transmission opportunity allowing only one of said nodes to send data to the network at any one time.

In many embodiments, as part of known PLCA processes, transmission opportunities are opened in succession after each other, so that only one node 4 at a time is allowed to broadcast data to the network 6, in order to avoid collisions and data loss.

In the illustrated example, the transmission opportunities are opened according to the PLCA standard mentioned above.

In practice, the maximum length of the transmission opportunity 36 is the same for all nodes 34. However, the length of the transmission opportunity 36 may vary between the different nodes 4, depending on the effective amount of data that needs to be transmitted by said node.

In some examples, the second coordinator node can be configured to give transmission opportunities into the nodes 4 according to a specific predefined order.

In the example of FIG. 3, the first transmission opportunity is given to the “Node 0”, then the second transmission opportunity is given to the “Node 1”, and so on in increasing order until the last node, “Node n”. Other embodiments are nonetheless possible.

In some embodiments, the second coordinator node is the same node as the first coordinator node and is assigned the PLCA identifier of the initial transmit opportunity.

However, in other embodiments, the second coordinator node is different from the first coordinator node and is assigned a PLCA identifier different to the PLCA identifier of the initial transmit opportunity.

Once the last remaining node 4 has been given a transmit opportunity, the process starts over with the first coordinator node sending a new PLCA beacon 32 to initiate a new transmission cycle.

An aspect of the invention is more particularly concerned with automatically allocating PLCA identifiers to the nodes 4, as well as automatically allocating the roles of the first coordinator node (the PLCA coordinator) and optionally the second coordinator node (the identifier-manager coordinator node). Exemplary methods are described in reference to FIGS. 4-7.

In many embodiments, the method for coordinating nodes according to embodiments of the invention comprises steps consisting of:
repeatedly listening for a selected coordinator broadcast to the network during one or more listening cycles, each listening cycle being at least as long as a transmission cycle,
selecting a node as selected coordinator node if capable of being so selected and if said node has not detected said selected coordinator broadcast during a listening cycle,
not selecting a node as selected coordinator node if said node has received said selected coordinator broadcast during at least one listening cycle.

As illustrated by FIG. 4, automatically selecting the first coordinator node as the selected coordinator node comprises, by each node 4 of the network:
repeatedly listening for a selected coordinator broadcast comprising a PLCA beacon during one or more first listening cycles, each first listening cycle being at least as long as a transmission cycle,
selecting a node as the first coordinator node if capable of being the first coordinator node and if said node has not detected said PLCA beacon during one first listening cycle,
not selecting a node as the first coordinator node if said node has received said PLCA beacon during at least one first listening cycle, and upon selection of the first coordinator node, assigning an initial transmit opportunity to the newly selected first coordinator node.

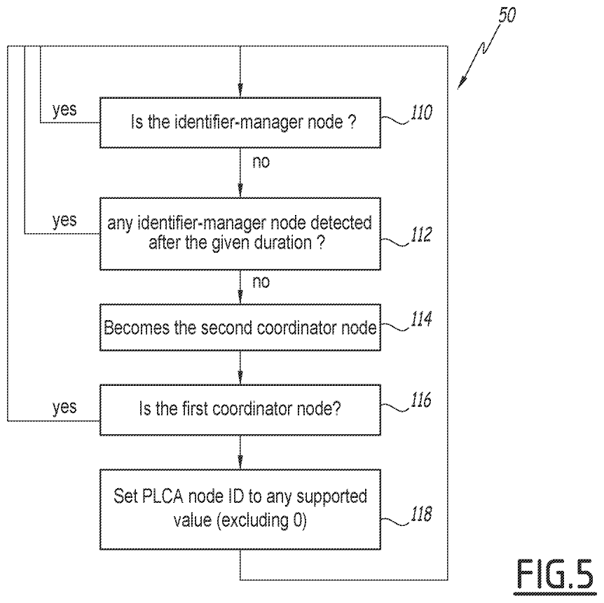

And, as illustrated by FIG. 5, automatically selecting the second coordinator node as the selected coordinator node comprises, by each node of the network:
repeatedly listening for a selected coordinator broadcast comprising a second coordinator node presence signal during one or more second listening cycles, each second listening cycle being at least as long as a transmission cycle,
selecting a node as the second coordinator node if capable of being the second coordinator node and if said node has not detected the second coordinator node presence signal during one second listening cycle,
not designating a node as the second coordinator node if said node has received the second coordinator node presence signal during at least one second listening cycle.

It is to be noted that, in many alternative embodiments, the method steps described herein could be executed in a different order. One or more method steps could be omitted or replaced by functionally equivalent method steps. One or more method steps could be combined into a method step, or dissociated into different method steps.

According to this method, the first coordinator node and optionally also the second coordinator node are automatically selected prior to any automatic allocation of the transmit opportunity slots to the other device nodes. Unique PLCA identifiers can thus be allocated dynamically and in a decentralized fashion to the nodes 4 of the network 6. The system can thus update itself to allow for fewer or for more nodes. A continual looped cycle on the part of the ordinary device nodes allows for an automatic re-selection of a different first and/or second coordinator nodes after network start-up in case one or the other coordinator nodes disappear. In that case, thanks to the invention, a new coordinator node will be elected to replace the missing coordinator node, in order to allow the PLCA system to continue to operate.

This distributed solution does not depend on any particular privileged device on the network. Instead, the method is decentralized, as it is implemented by at least several nodes of the network.

Thus, even if one or more devices are removed from the system 2 during operation, for example due to maintenance, or repairs, or replacement, or any other reason, then the PLCA collision avoidance system can resiliently continue to operate, by distributing new identifiers and/or new roles to the remaining devices. Similarly, if new devices are added to the system 2 during operation, the PLCA collision avoidance system can accommodate the newly installed devices, by distributing new identifiers and/or new roles to the new devices.

In many embodiments, the method comprises automatically assigning a unique PLCA identifier to each node by means of:
a) each node broadcasting its presence, optionally broadcasting its presence periodically, to the network so that the second coordinator node may assign any unassigned PLCA identifiers to any unassigned nodes; and/or
b) each unassigned node deducing its PLCA identifier from a PLCA identifier message broadcast, optionally broadcast periodically, by the second coordinator node.

In many embodiments, the second coordinator node repeatedly broadcasts the list of unallocated PLCA identifiers to the network until all nodes have been allocated a transmit PLCA identifier from the list of unallocated PLCA identifiers.

Each assigned node (e.g. a node allocated with a PLCA identifier) is configured to signal its presence and/or transmit data during its transmit opportunity, until said node is disconnected from or unavailable to the network.

Each assigned node listens for the PLCA beacon and broadcasts a heartbeat and/or data during its transmit opportunity, until said node is disconnected from the network; and/or becomes unassigned (e.g. having its PLCA identifier removed).

According to advantageous embodiments, during operation, the second coordinator node updates the PLCA identifier list to record the allocated PLCA identifiers.

In other words, the second coordinator node is configured to periodically update any PLCA identifier message with any changes in the pool of PLCA identifiers.

The second coordinator node updates the PLCA identifier list to free or remove an allocated PLCA identifier when the corresponding node is detected as disconnected from the network or unassigned (e.g. having its PLCA identifier removed).

In other words, the second coordinator node is arranged to free a PLCA identifier of a node disconnected from, or unavailable to, the network and update the pool of PLCA identifiers accordingly.

For example, a node 4 is considered to be disconnected from the network or unassigned (e.g. having its PLCA identifier removed or unallocated) when no heartbeat and/or no data has been received from said node 4 during a predefined period of time, which may be longer than the duration of the transmission cycle.

Other embodiments are nonetheless possible.

Similarly, the second coordinator node updates the PLCA identifier list to allocate a new PLCA identifier when a new corresponding node is detected as newly connected or newly assigned to the network.

In other words, the second coordinator node is arranged to assign a free PLCA identifier to a new node connected or available to the network and update the pool of PLCA identifiers accordingly.

In some embodiments, the allocation of an unallocated PLCA identifier from the list to a new node can be based on a predefined scheme, for example by randomly selecting an unallocated PLCA identifier from the list, or by selecting the first unallocated PLCA identifier from the list, of by selecting an unallocated PLCA identifier from the list using a predefined order.

Preferably, the second coordinator node periodically broadcasts to the network the pool (the list) of PLCA identifiers updated with any changes detected by the second coordinator node.

In some embodiments, the list of PLCA identifiers may be a list of elements, or a linked list, or a database, or any appropriate data structure.

Each PLCA identifier is a number (e.g., an integer comprised between 0 and 255, as specified in the standard IEEE 802.3cg referenced above) uniquely identifying the node in the network 4. The PLCA identifier is used to define the order in which the nodes are given transmit opportunities, as specified in the standard IEEE 802.3cg referenced above.

As illustrated in the drawings, during each transmission cycle, the node with the PLCA identifier “0” is the first to receive a transmit opportunity, the node with the PLCA identifier “1” is the second to receive a transmit opportunity, and so on, until the node with the PLCA identifier “n” is the last to receive a transmit opportunity.

Preferably, the list (or pool) of PLCA identifiers is stored in memory of the second coordinator node.

The list may associate, to each allocated PLCA identifier, a unique physical identifier (UID) identifying the corresponding node of the network (such as a hardware identifier of that node, e.g. a MAC address of that node).

In addition, each node comprises a memory for storing a unique PLCA identifier (PLCA ID) assigned to said node. Each node stores its unique physical identifier (UID) in its memory. Optionally, the unique physical identifier (UID) of each node is programmable.

An embodiment 40 of the method for designating the first coordinator node is illustrated at FIG. 4. This method 4 is described in reference to a single node 4, but in practice an instance of this method is executed concurrently by several nodes, or even by every node 4 of the network.

During a step 100, after initialization, each node 4 automatically checks whether it is already the first coordinator node, for example by checking the state or value of its role identifier 22.

If the node 4 is identified as the first coordinator node, then the process stops successfully.

If the node 4 is not identified as the first coordinator node, then during a step 102, the node 4 checks whether the first coordinator node has been identified on the network 6 during the duration of the first listening cycle, for example by checking whether a PLCA beacon 32 has been received during the first listening cycle.

If the first coordinator node has been identified during the first listening cycle, then the process stops successfully.

Otherwise, during a step 104, the node 4 designates itself as the new first coordinator node, for example by setting its PLCA identifier (PLCA ID) to 0 (to become the first node to receive a transmit opportunity). The role identifier 22 of the node 4 may be updated in consequence.

An embodiment 50 of the method for designating the second coordinator node is illustrated at FIG. 5. This method is described in reference to a single node 4, but in practice an instance of this method is executed concurrently by many nodes 4, preferably by every node 4 of the network.

During a step 110, after initialization, each node 4 automatically checks whether it is already the second coordinator node, for example by checking the state or value of its role identifier 22.

If the node 4 is identified as the second coordinator node, then the process stops successfully.

If the node 4 is not identified as the second coordinator node, then during a step 112, the node 4 checks whether the second coordinator node has been identified on the network 6 during the second listening cycle. For example, the node 4 checks whether a list of PLCA identifiers has been broadcasted on the network 6 during the second listening cycle.

If the second coordinator node has been identified during the second listening cycle, then the process stops successfully.

Otherwise, during a step 114, the node 4 designates as the second coordinator node.

Then, at step 116, the newly designated second coordinator node determines whether it already has the role of first coordinator node.

In case the node is identified as being both the first coordinator node and the second coordinator role, then the method stops successfully.

If the newly designated second coordinator node is not the first coordinator node, then at step 118, the newly designated second coordinator node sets its PLCA identifier of the (PLCA ID) to a different value than the PLCA identifier of the first coordinator node (e.g., a value different from 0). For example, the newly designated second coordinator node is the “Node 1” identified on FIGS. 1 and 3.

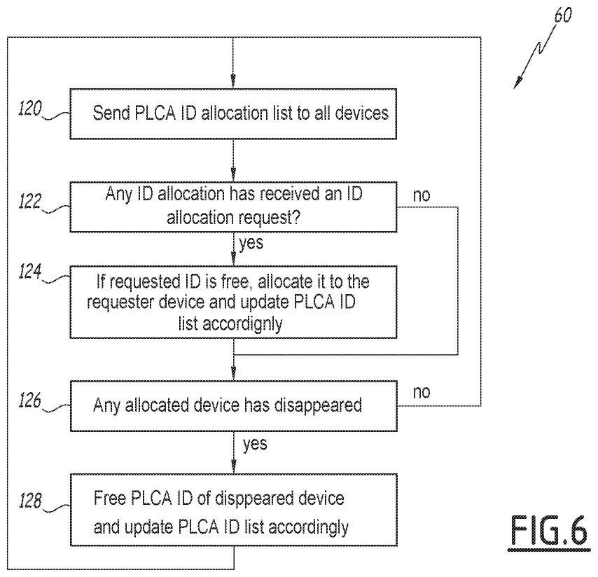

An embodiment 60 of the method for managing PLCA identifiers by the second coordinator node is illustrated by FIG. 6.

For example, during a step 120, after having been assigned the role of second coordinator node, the second coordinator node sends a list of PLCA identifiers (PLCA ID) to the remaining nodes 4, for example by broadcasting the list to all nodes 4 of the network.

In some embodiments, if the nodes know in advance all possible PLCA identifiers, the second coordinator node may broadcast a list of the allocated PLCA identifiers, each node being then arranged to automatically determine, by comparing the list of already allocated PLCA identifiers with the list of all possible PLCA identifiers, whether their requested identifier has already been allocated.

In other embodiments, the second coordinator node may broadcast a list of free (i.e. unallocated) PLCA identifiers and send to each requester node independently a confirmation that their requested id has been successfully allocate.

Thus, in these various embodiments, the nodes are able to know which PLCA identifiers are free and whether or not the requested PLCA identifier has been successfully allocated.

At step 122, the second coordinator node checks whether any PCLA identifier allocation request has been received from any node 4 (or device) during a certain time limit, for example during the transmission cycle.

If yes, then during a step 124, the second coordinator node allocates the requested PLCA identifier to the requester node 4, provided that the requested PLCA identifier is available, i.e. has not been allocated to another node 4. The requested PLCA identifier is not allocated if it is found to be unavailable by the second coordinator node. The method then jumps to step 126.

It no PCLA identifier allocation request has been received during the time limit (during step 122), then the method jumps directly to the step 126.

During a step 126, the second coordinator node checks whether any node 4 with an allocated PLCA identifier has disappeared during a certain time limit, for example during the transmission cycle.

If, during step 126, one or more nodes 4 with an allocated PLCA identifier are found to have disappeared, then, during a step 128, the corresponding PLCA identifier(s) are freed and the list is updated accordingly. For example, the reference (such as the UID mentioned above, e.g. the network address or the MAC Address) identifying the corresponding node of the network is removed from the list of PLCA identifiers stored in memory of the second coordinator node.

The updated list is then sent to the nodes 4. For example, steps 120 through 128 may be repeated, preferably periodically, during operation of the system 2. In some cases, instead of receiving a full list of all PLCA identifiers, the nodes 4 may only receive an information on whether or not their request for a PLCA identifier has been satisfied.

In many embodiments, whenever a new unallocated device is appearing, the step 122 may consist of detecting the appearance of this new unallocated device on the network by any means (e.g. the node may signal its presence to the second coordinator by an appropriate signal, such as heartbeat message or the like). The step 126 then consists in allocating a free, unallocated PLCA identifier to this new device (provided that there is still unallocated PLCA identifiers ready to be assigned to this new device) and informing said node of its new PLCA identifier, by any means possible.

An embodiment 70 of the method for requesting a PLCA identifier by a node 4 is illustrated by FIG. 7. In this embodiment, for the sake of simplicity, two different sub-functions (with different goals) are combined: one function related to requesting a PLCA identifier by a node, and one function dedicated to signaling the node's presence to the second coordinator node, although other embodiments are possible.

This method is described in reference to a single node 4, but in practice an instance of this method is executed concurrently by every node 4 of the network.

Initially, during a step 130, the node 4 verifies whether the list of PLCA identifiers (the pool of identifiers) has been received from the second coordinator node.

For example, the step 130 is executed after the node 4 has executed the methods for self-allocating the role of first coordinator node and second coordinator node (e.g., steps 100-104 and 110-118).

If the list of PLCA identifiers has been correctly received, then during a step 132, the node 4 verifies if a PLCA identifier has been allocated to said node 4, e.g. by reading the contents of the received list of PLCA identifiers.

If no list of PLCA identifiers has been received, then the node 4 continues to listen for the list.

If, during step 132, a PLCA identifier is found to have been allocated to said node 4, then, during a step 134, the node 4 sets its PLCA identifier 24 to the allocated PLCA identifier (e.g. by updating its PLCA identifier 24 with the value of the allocated PLCA identifier read from the received list of PLCA identifiers).

Then, once the allocated PLCA identifier has been set, during a step 134, the node 4 notifies its presence to the second coordinator node, e.g. by broadcasting a heartbeat to the network, or by sending one or more packets of data during the time window corresponding to its own transmit opportunity.

If after the step 132 the node 4 identifies that it has not been allocated any PLCA identifier, then during a step 138, the node 4 sends a request to the second coordinator node for requesting a PLCA identifier.

The embodiments and alternatives described above may be combined with each other in order to create new embodiments.

1. A method for configuring a plurality of nodes in a 10BASE-T1S Ethernet network, said nodes being configured to implement a physical layer collision avoidance (PLCA) process, wherein the network comprises:
a first coordinator node being configured to periodically send a PLCA beacon to the network to initiate each respective transmission cycle of a PLCA process; and
a second coordinator node being configured to open a plurality of separate transmission opportunities (TO) each with a unique PLCA identifier (PLCA ID) from a pool (P) of PLCA identifiers provided by the second coordinator, each PLCA identifier being assignable by the second coordinator to a unique physical identifier (UID) each provided by a respective node, each transmission opportunity allowing only one of said nodes to send data to the network at any one time,
wherein the method comprises automatically selecting a selected coordinator node being at least one of the first coordinator node and the second coordinator node, wherein automatically selecting a selected coordinator node comprises, by each node of the network:
repeatedly listening for a selected coordinator broadcast to the network during one or more listening cycles, each listening cycle being at least as long as a transmission cycle,
selecting a node as selected coordinator node if capable of being so selected and if said node has not detected said selected coordinator broadcast during a listening cycle,
not selecting a node as selected coordinator node if said node has received said selected coordinator broadcast during at least one listening cycle.

2. The method according to claim 1, wherein automatically selecting the first coordinator node as the selected coordinator node comprises, by each node of the network:
repeatedly listening for a selected coordinator broadcast comprising a PLCA beacon during one or more first listening cycles, each first listening cycle being at least as long as a transmission cycle,
selecting a node as the first coordinator node if capable of being the first coordinator node and if said node has not detected said PLCA beacon during one first listening cycle,
not selecting a node as the first coordinator node if said node has received said PLCA beacon during at least one first listening cycle, and
upon selection of the first coordinator node, assigning an initial transmit opportunity to the newly selected first coordinator node.

3. The method according to claim 1, wherein automatically selecting the second coordinator node as the selected coordinator node comprises, by each node of the network,
repeatedly listening for a selected coordinator broadcast comprising a second coordinator node presence signal during one or more second listening cycles, each
second listening cycle being at least as long as a transmission cycle, selecting a node as the second coordinator node if capable of being the second coordinator node and if said node has not detected the second coordinator node presence signal during one second listening cycle,
not designating a node as the second coordinator node if said node has received the second coordinator node presence signal during at least one second listening cycle.

4. The method according to claim 1, wherein the second coordinator node is the same node as the first coordinator node and is assigned the PLCA identifier of the initial transmit opportunity.

5. The method according to claim 1, wherein the second coordinator node is different from the first coordinator node and is assigned a PLCA identifier different to the PLCA identifier of the initial transmit opportunity.

6. The method according to claim 1, wherein the method comprises automatically assigning a unique PLCA identifier to each node by means of:
a) each node broadcasting its presence, optionally broadcasting its presence periodically, to the network so that the second coordinator node may assign any unassigned PLCA identifiers to any unassigned nodes; and/or
b) each unassigned node deducing its PLCA identifier from a PLCA identifier message broadcast, optionally broadcast periodically, by the second coordinator node.

7. The method according to claim 6, wherein the second coordinator node periodically updates any PLCA identifier message with any changes in the pool of PLCA identifiers.

8. The method according to claim 6, wherein each assigned node signals its presence and/or transmits data during its transmit opportunity, until said node is disconnected from or unavailable to the network.

9. The method according to claim 6, wherein the second coordinator node is arranged to free a PLCA identifier of a node disconnected from, or unavailable to, the network and update the pool of PLCA identifiers accordingly.

10. The method according to claim 6, wherein the second coordinator node is arranged to assign a free PLCA identifier to a new node connected or available to the network and update the pool of PLCA identifiers accordingly.

11. The method according to claim 6, wherein the second coordinator node comprises a memory for storing the pool of PLCA identifiers.

12. The method according to claim 6, wherein each node comprises a memory for storing a unique PLCA identifier (PLCA ID) assigned to said node.

13. The method according to claim 12, wherein each node stores its unique physical identifier (UID) in its memory.

14. The method according to claim 1, wherein the unique physical identifier (UID) of each node is programmable.

15. A system comprising a plurality of nodes connected to a 10BASE-T1S Ethernet network, said nodes being configured to implement a physical layer collision avoidance (PLCA) process, each node comprising a processor, a memory and a network interface configured to implement a network stack,
wherein the network comprises:
a first coordinator node being configured to periodically send a PLCA beacon to the network to initiate each respective transmission cycle of a PLCA process; and
a second coordinator node being configured to open a plurality of separate transmission opportunities (TO) each with a unique PLCA identifier (PLCA ID) from a pool (P) of PLCA identifiers provided by the second coordinator, each PLCA identifier being assignable by the second coordinator to a unique physical identifier (UID) each provided by a respective node, each transmission opportunity allowing only one of said nodes to send data to the network at any one time,
wherein the memory is storing instructions configured to cause the processor to implement a method for configuring a plurality of nodes,
wherein the method comprises automatically selecting a selected coordinator node being at least one of the first coordinator node and the second coordinator node, wherein automatically selecting a selected coordinator node comprises, by each node of the network:
repeatedly listening for a selected coordinator broadcast to the network during one or more listening cycles, each listening cycle being at least as long as a transmission cycle,
selecting a node as selected coordinator node if capable of being so selected and if said node has not detected said selected coordinator broadcast during a listening cycle,
not selecting a node as selected coordinator node if said node has received said selected coordinator broadcast during at least one listening cycle.
